(19) United States
(12) Patent Application Publication
(10) Pub. No.: US 2011/0116901 A1
(43) Pub. Date: May 19, 2011

(54) Fall Prevention Assembly for Parking Lifts

(75) Inventor: Van Stokes, Nutley, NJ (US)

(73) Assignee: Stokes Industries, Inc., Nutley, NJ (US)

(21) Appl. No.: 13/011,247

(22) Filed: Jan. 21, 2011

Related U.S. Application Data
(63) Continuation of application No. 11/818,040, filed on Jun. 12, 2007, now abandoned.
Application No. 11/818,040 is a continuation of application No. 10/447,976, filed on May 29, 2003, now abandoned.
(60) Provisional application No. 60/385,194, filed on Jun. 3, 2002.

(51) Int. Cl. B66F 7/28; E04H 6/06; E04H 6/18

(52) U.S. Cl. 414/240

(57) ABSTRACT

A fall prevention assembly for vertical lift systems for storage and in particular for parking motor vehicles, the lift system comprising a frame extending upward from a base and at least one platform that is raised vertically within that frame responsive to a lift mechanism upon which a vehicle is parked, the fall prevention assembly comprising a series of metal bars of sufficient size and strength to resist bending attached to the base of the unit and extending upward through a series of bushings mounted strategically on each platform usually at the corners. These bushings can be designed with ridges or teeth inside. As long as the platform or platforms remain level and in proper alignment with the lifting system and within the frame the bushings simply move up and down along the metal bars. In the case of the failure of a lifting means the platform or platforms would become unlevel or tilt and the bushings would bind upon the metal bar. The placement of the bushings on the platform as well as the length of the bushings and the closeness of the fit between the metal bar and the bushing would determine the amount the platform would be allowed to tilt.

### CROSS REFERENCE TO RELATED APPLICATIONS

This application is a continuation of U.S. patent application No. 11/818,040, filed Jun. 12, 2007, the entirety of which is incorporated herein by reference, and a continuation of U.S. patent application No. 10/447,976, filed May 29, 2003, abandoned, and claims the benefit of U.S. Provisional Patent Application Ser. No. 60/385,194, filed Jun. 3, 2002.

### BACKGROUND OF THE INVENTION

1.Field of the Invention

The present invention relates to a fall prevention assembly and in particular to a fall prevention assembly used on vertical lift systems particularly adaptable for parking motor vehicles.

2. Description of the Prior Art

Multi-level parking systems for automobiles, trucks, etc., have been used for many years. Single level parking is not cost effective, especially in urban areas. Multi-story parking buildings are utilized, but are expensive to construct. Vertical lift systems have been widely employed to economically increase the number of cars that can be parked in any given location, but the known systems are subject to failure of the mechanical lifting means causing damage to vehicles and creating a danger to persons. U.S. Pat. Nos. 2,579,688; 3,387,722; 3,706,356; 3,750,899; and 4,209,276 all disclose different types of vertical lift systems. Applicant is also the co-holder of U.S. Pat. No. 4,674,938 for a vertical parking system.

The difficulty with vertical lift systems heretofore was that the vehicle, which is parked on a platform that is then lifted to a certain level and latched into that position, would become displaced or fall off said platform if the lifting means supporting the platform were to fail, either while the vehicle is being lifted or lowered, or in some cases after it has been latched into position. A further problem is that once the failure has occurred it is difficult to remove the vehicles from the vertical lift system. Some vertical lift systems park three or more cars vertically. The failure of the lifting means usually requires the use of a crane or other such heavy equipment to remove the vehicles. A number of fall prevention systems, sometimes known as slack chain or slack cable safety device, have been devised for various types of lifts in the past however, these devices are active in nature, i.e. have some means of detecting whether or not the lifting member is in tension or has become slack, and then react, usually by means of a spring, to lock the lifting platform at its current position. With this system once the failure has occurred it is necessary to first raise and then support the platform by some external means in order to disengage the latching mechanism. It is then necessary to maintain this external support while lowering the platform.

Applicant's assembly addresses the problem and limits the tilt of a platform and allows for the lowering of a platform that is atilt in response to a lift mechanism failure.

### SUMMARY OF THE INVENTION

A fall prevention assembly for vertical lift systems for storage and in particular for parking motor vehicles, the lift system comprising a frame extending upward from a base and at least one platform, that is raised vertically within that frame, upon which a vehicle is parked, the fall prevention assembly comprising a series of metal bars of sufficient size and strength to resist bending attached to the base of the unit and extending upward through a series of bushings mounted strategically on each platform usually at the corners. These bushings can be designed with ridges or teeth inside. As long as the platform or platforms remain level and in proper alignment with the lifting system and within the frame the bushings simply move up and down along the metal bars. In the case of the failure of a lifting means the platform or platforms would become unlevel or tilt and the bushings would bind upon the metal bar. The placement of the bushings on the platform as well as the length of the bushings and the closeness of the fit between the metal bar and the bushing would determine the amount the platform would be allowed to tilt.

In addition to restricting the amount of tilt the platform will assume in the case of a lifting means failure this assembly will allow the platforms to be lowered and the vehicles safely removed from the platforms without the use of any external devices such as cranes or blocks and tackles, etc. The bushings would simply slide down the bar maintaining the same amount of platform tilt until the platform reached its lowermost level at which time the vehicle could be safely removed.

An object of the present invention is to provide a simple, safe, and cost effective assembly to prevent platforms from tilting enough to allow the vehicles parked on them to fall off in the event of a failure of the lifting means in a multi-level parking system.

A further object of the present invention is to provide for a simple, safe, and cost effective assembly to lower the platforms after a failure of the lifting means in a multi-level parking system.

### BRIEF DESCRIPTION OF THE DRAWINGS

These and other objects of the present invention will become apparent, particularly when taken in view of the following drawings wherein:

FIG. 1 is a perspective view of a typical multi-level parking assembly;

FIG. 2 is a schematic view of the platform connection in a typical multi-level parking assembly showing the placement of the metal bar and bushing of the present invention;

FIG. 3 is a perspective view of FIG. 2 illustrating the placement of the metal bar and bushing and the means of tensioning the bar in the present invention;

FIG. 4 is a top view showing how the platform is connected within the frame in a typical multi-level parking system;

FIG. 5 is a close-up view of one of the corners shown in FIGS. 4; and

FIGS. 6 through 9 illustrate the conditions that exist with the present invention after the failure of a lifting means.

### DETAILED DESCRIPTION OF THE INVENTION

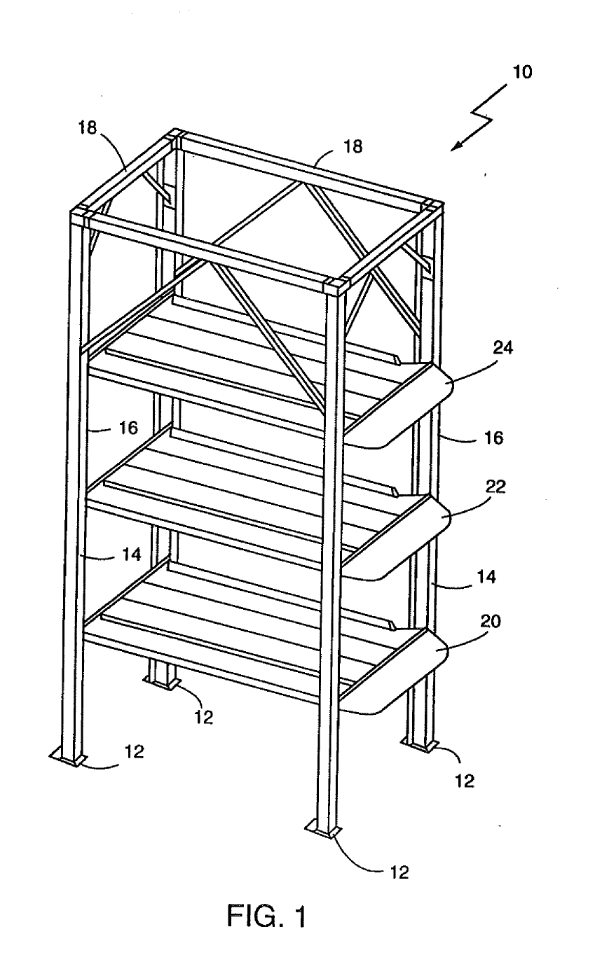

FIG. 1 is a perspective view of a typical multi-level parking system designated generally 10. In this particular perspective view, the parking system contains three platforms or parking levels. The multi-level parking system consists of a number of base plates 12 upon which a structural frame 14 is constructed. The constructual frame 14 consists of a plurality of vertical support members 16 and horizontal support members 18 such that platforms 20, 22, and 24 are supported within the frame to park vehicles thereupon.

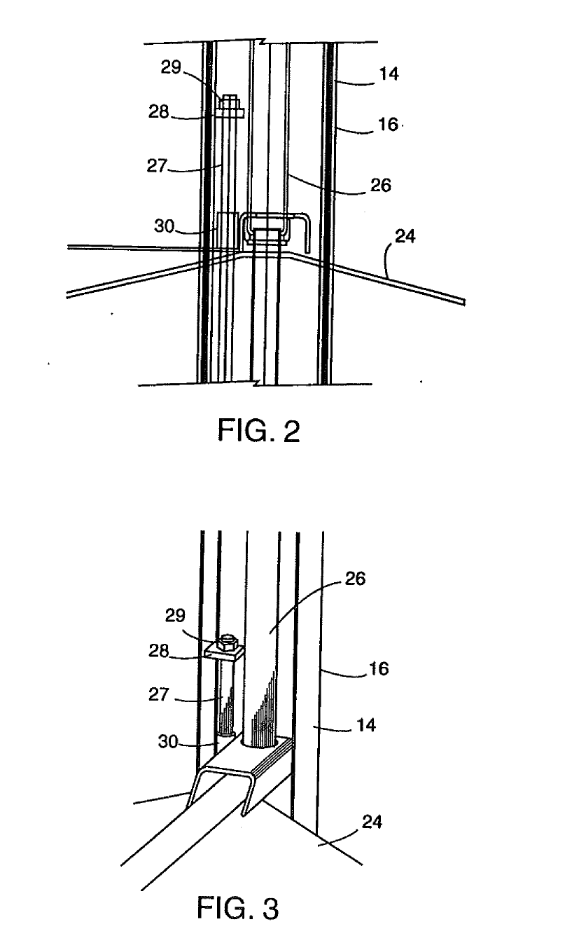

FIG. 2, a schematic side view, and FIG. 3, a perspective view, which illustrates the uppermost platform 24 connected to its lifting means 26 contained within the frame 14 and more specifically within the vertical support member 16. One of the metal bars 27 of the present invention, which is connected at one end to base plate 12, is shown extending through one of the metal bushings 30 of the current invention, which is attached to platform 24 near one corner close to the platform lifting means 26. The metal bar 27 passes through and is supported by a support plate 28, which is welded to the frame 14 and is tensioned by tensioning nut 29.

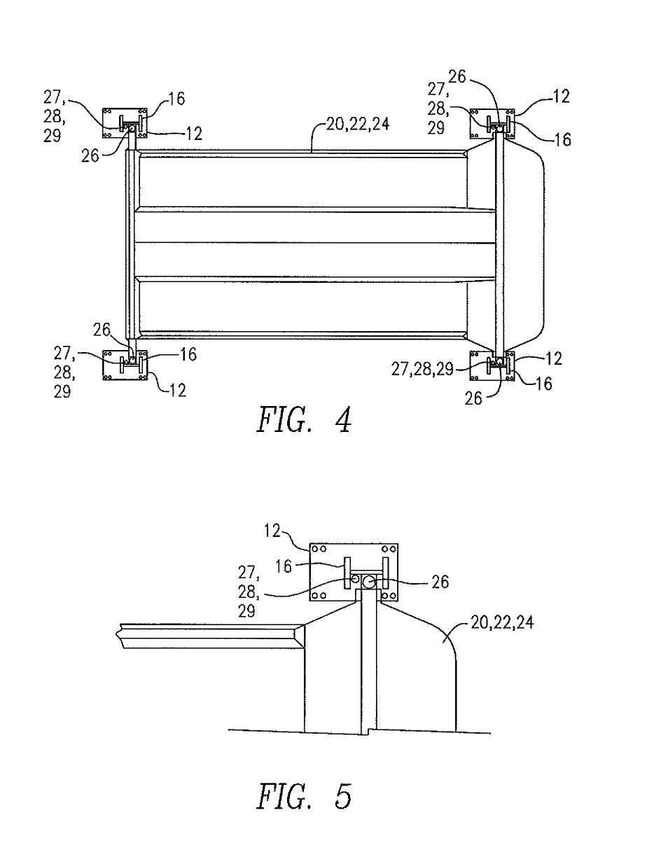

FIGS. 4 and 5 more clearly illustrate how the platforms 20, 22, and 24 of a typical multi-level parking system are contained within its vertical support members 16. These illustrations show how four sets of the metal bars 27, support plate 28, support nut 29, and bushings 30, of the current invention are positioned within the vertical support members 16.

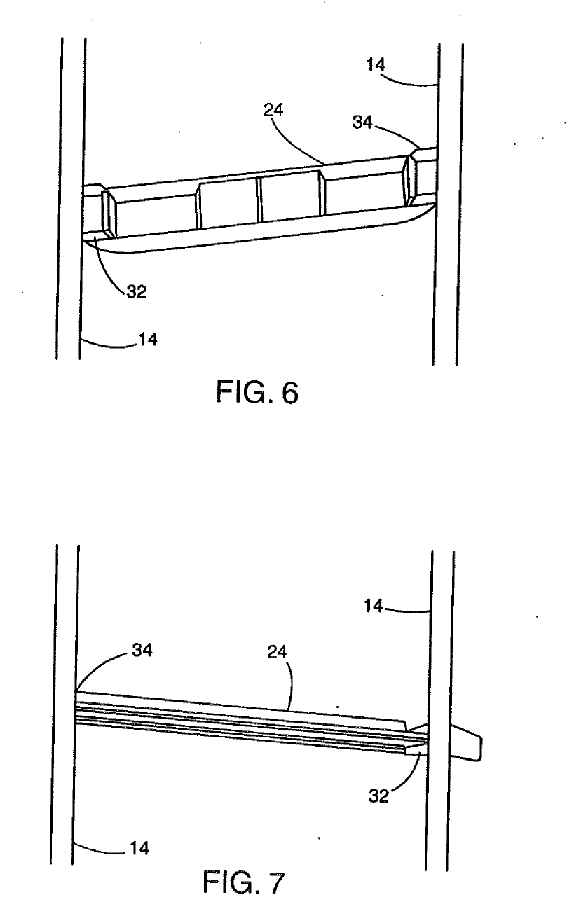

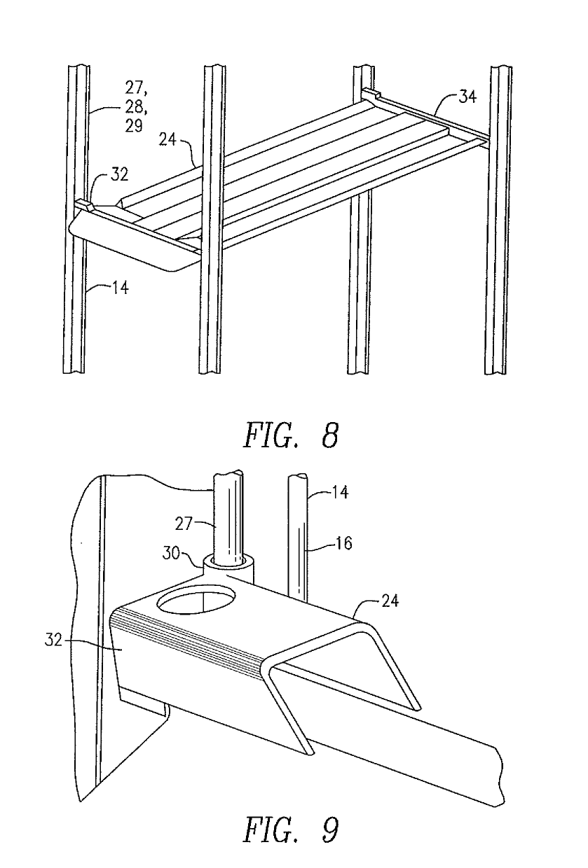

FIGS. 6, 7, and 8 illustrate the condition that exists when one of the lifting means of platform 24 has failed. In this case the lifting means that supported the corner 32 has failed. Corner 32 has attempted to move downward and towards the center of the frame 14 while corner 34, the diagonally opposite corner, is attempting to raise and move upward and towards the center of the frame 14.

FIG. 9 illustrates how the bushings 30, located in corners 32 and 34, tilt and bind upon the metal bar 27, which stops the platform from tilting further. The matching of ridges or teeth within the bushing 30 will increase its ability to bind upon the metal bar 27.

With the current invention, in the event of failure of a lifting means, the platform can be lowered by its normal method and the bushing will continue to slide down the metal bar maintaining only a small amount of platform tilt until the platform reaches its lowermost position where any vehicles parked on the platform can be safely removed.

While the preceding describes a common vertical lift system that lifts a platform or series of platforms from the four corners of the platforms, it can be seen that this invention is adaptable to any system that uses any quantity of vertical support members such as a cantilever system that uses only two vertical supports.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed is:

1. A fall prevention assembly for use on a vertical lift system operable for parking motor vehicles wherein said vertical lift system comprises a plurality of structural base plates having a structural frame constructed thereon, said structural frame comprising a plurality of vertical support members and horizontal support members for the support and vertical movement of a plurality of platform members by means of a self-contained lift mechanism, said platforms for the receipt and parking of vehicles thereon, said fall prevention system comprising: a plurality of vertically disposed guide rods secured to and extending upwardly from said base plate to a point above the highest vertically disposed platform member and being secured at an uppermost point to said structural frame; at least one bushing member secured to each corner of each of said platform members, each of said bushing members slidably disposed on said vertically disposed metal guide rod during normal operation of said platform members, said bushing member selectively engaging said vertically disposed metal guide rod upon said tilting of said ramp member in response to a lift mechanism failure, thereby limiting the tilt of the platform member and allowing for the lowering of said platform member and removal of said vehicle.

2. The fall prevention assembly in accordance with claim 1 wherein said bushing is formed with ridges or teeth about its interior surface for binding contact with said vertically disposed metal guide rod when said platform member tilts in response to said lift mechanism failure.

3. The fall prevention assembly in accordance with claim 1 wherein said plurality of vertically disposed metal guide rods comprises two guide rods in a cantilever lift system.

4. The fall prevention assembly in accordance with claim 3 wherein two of said corners of said platform member in said cantilever lift system have disposed thereon a bushing member slidably positioned about said vertically disposed guide rod.

5. The fall prevention assembly in accordance with claim 4 wherein said bushing is formed with ridges or teeth about its interior surface for binding contact with said vertically disposed metal guide rod when said platform member tilts in response to said lift mechanism failure.
